(19) United States
(12) Patent Application Publication
(10) Pub. No.: US 2005/0045078 A1
(43) Pub. Date: Mar. 3, 2005

(54) Security revolving door assembly

(76) Inventor: Yen-Kun Chen, San-Chung City (TW)

Correspondence Address: NIXON & VANDERHYE, PC, 1100 N GLEBE ROAD, 8TH FLOOR, ARLINGTON, VA, 22201-4714, US

(21) Appl. No.: 10/724,719

(22) Filed: Dec. 2, 2003

(30) Foreign Application Priority Data
Sep. 3, 2003 (TW) 92124353

(51) Int. Cl. E05G 5/00

(52) U.S. Cl. 109/8

(57) ABSTRACT

A security revolving door assembly includes a revolving door and a controlling unit. The revolving door has a rotary vertical shaft, a vertical lateral wall extending circumferentially relative to the shaft, and a plurality of door wings extending radially from the shaft. The door wings have distal ends, include first and second door wings, are rotatable along with the shaft, and define with the lateral wall a trap space when the first and second door wings reach respectively first and second positions. The distal ends of the first and second door wings confront the lateral wall when the first and second door wings reach respectively the first and second positions. The controlling unit is operable so as to stop rotation of the door wings as soon as the door wings define the trap space.

### BACKGROUND OF THE INVENTION

1. Field of the Invention

The invention relates to a revolving door assembly, more particularly to a security revolving door assembly.

2. Description of the Related Art

Banks, jewelry stores, and other places of business are mostly equipped with different safety precautions against robberies and holdups. For example, when a robber robs a bank and intends to escape through an automatic or a revolving door of the bank, a bank employee can control and stop movement of the door so as to block exit passage of the robber from the premise, thereby facilitating capture of the robber.

Although the design of the aforementioned door can restrict the robber within the premise, the robber is not isolated from other people in the premise so that a hostage drama or injury to other people often occurs.

### SUMMARY OF THE INVENTION

Therefore, the object of the present invention is to provide a security revolving door assembly that is capable of overcoming the aforementioned drawbacks of the prior art.

According to this invention, a security revolving door assembly comprises a revolving door and a controlling unit. The revolving door has a rotary vertical shaft, a vertical lateral wall with an arc-shaped cross-section and extending circumferentially relative to the vertical shaft, and a plurality of door wings mounted on and extending radially from the shaft toward the lateral wall. The door wings have distal ends disposed away from the shaft, and include a first door wing and a second door wing following the first door wing. The door wings are rotatable along with the shaft, and define with the lateral wall a trap space when the first and second door wings reach respectively first and second positions which are spaced apart angularly. The second position lags the first position. The distal ends of the first and second door wings confront the lateral wall when the first and second door wings reach respectively the first and second positions. The controlling unit is coupled to the revolving door and is operable so as to stop rotation of the door wings as soon as the door wings define the trap space.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a security revolving door assembly according to the present invention;

FIG. 2 is a top sectional view of the preferred embodiment;

FIG. 3 is a fragmentary side sectional view of the preferred embodiment;

FIG. 4 is a view substantially similar to that of FIG. 3, illustrating a second plunger moving away from a first plunger when a second electromagnetic device is energized;

FIG. 5 is a view substantially similar to that of FIG. 2, illustrating how a passerby is trapped when first and second door wings are located at first and second positions respectively; and

FIG. 6 is a view substantially similar to that of FIG. 4, illustrating how a first engaging portion engages a second engaging portion.

### DETAILED DESCRIPTION OF THE PREFERRED EMBODIMENT

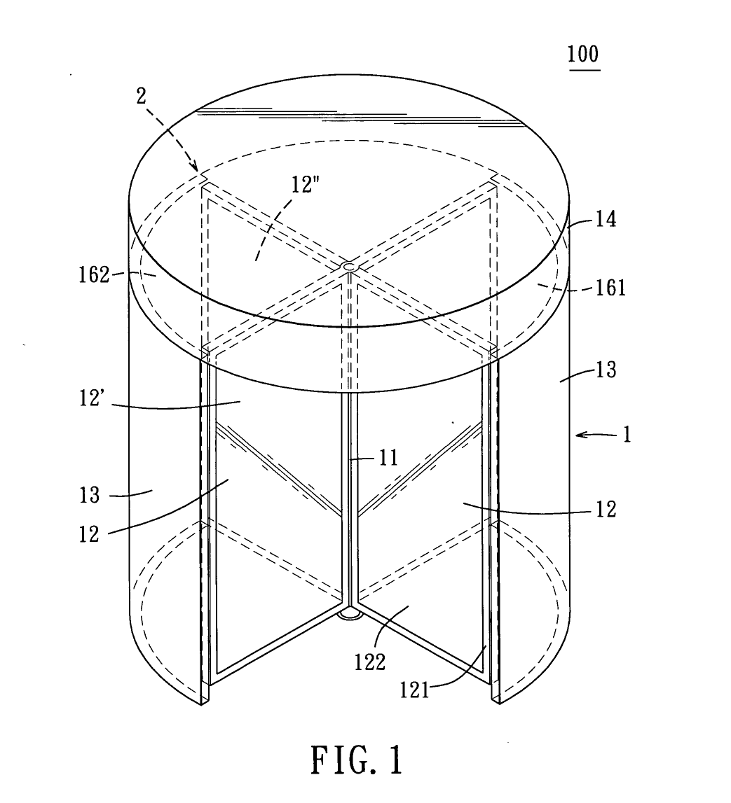

Referring to FIGS. 1 to 6, the preferred embodiment of a security revolving door assembly 100 according to the present invention is shown to comprise a revolving door 1, a stationary seat 14, and a controlling unit. The security revolving door assembly 100 is adapted to be applied in banks, jewelry stores, hi-class dress shops, art museums, or other places that require security against robbery.

The revolving door 1 is substantially similar to other currently available revolving doors, and has a rotary vertical shaft 11 with a bottom portion journalled to the ground of a gate 200 in a conventional manner, two opposite vertical lateral walls 13, each of which has an arc-shaped cross-section and extends circumferentially relative to the vertical shaft 11, and a plurality of door wings 12 mounted on and extending radially from the shaft 11 toward the lateral walls 13. The lateral walls 13 are connected to and are disposed between two outer walls 201 of the gate 200. The revolving door 1 has an entrance side 151 and an exit side 152 opposite to the entrance side 151.

The door wings 12 are equiangularly spaced apart about the shaft 11, and have distal ends disposed away from the shaft 11. The door wings 12 are rotatable along with the shaft 11, and define with each lateral wall 13 a trap space 161, 162 (see FIGS. 1 and 5) when a successive pair of door wings 12, for instance, first and second door wings specifically designated at 12′, 12″ in FIGS. 1 and 5, reach respectively first and second positions (1P, 2P) (see FIG. 5), which are spaced apart angularly. The second position (2P) lags the first position (1P) along a counterclockwise direction. In this situation, the distal ends of the first and second door wings 12′, 12″ confront the lateral walls 13 at two ends 131, 132 (see FIG. 5) of one of the lateral walls 13 so that a passerby 5 can be trapped within the trap space 162.

In this embodiment, the revolving door 1 has four door wings 12, each of which forms an angle of 90° with an adjacent door wing 12. Each door wing 12 includes a rectangular metal frame 121 (see FIG. 1), and a bullet-proof glass 122 (see FIG. 1) fitted within the metal frame 121 and capable of protection against an applied destructive force.

The stationary seat 14 (see FIGS. 1, 2 and 3) is disposed above the door wings 12, and includes an annular frame 141 mounted fixedly on top ends of the lateral walls 13, a cross frame 142 fitted within the annular frame 141, a bearing unit 143 disposed at the center of the cross frame 142 and sleeved on a top portion of the vertical shaft 11, and a top cover 144 covering detachably the annular frame 141 and the cross frame 142. A round top plate 145 is connected to a top end of each door wing 12, and is rotatable along with the door wings 12. The cross frame 142 has ends 1421 offset from the two ends 131, 132 of the lateral walls 13 by a lagging angle along a counterclockwise direction. A gap is formed between the cross frame 142 and the top plate 145 so that the cross frame 142 is not in direct contact with the top plate 145.

The controlling unit is coupled to the revolving door 1 and is operable so as to stop rotation of the door wings 12 as soon as the latter define the trap spaces 161, 162 with the lateral walls 13. The controlling unit includes a position detecting unit 2, a lock mechanism 4, and a drive unit 3. The position detecting unit 2 produces a first signal after the first door wing 12′ passes through the second position (2P), and includes a light sensor 22 mounted fixedly on the stationary seat 14 at a location corresponding to the second position (2P), and a plurality of reflector plates 23 mounted fixedly on the top plate 145 at locations corresponding to the positions of the door wings 12. The light sensor 22 senses a light signal when one of the reflector plates 23 moves past the second position (2P).

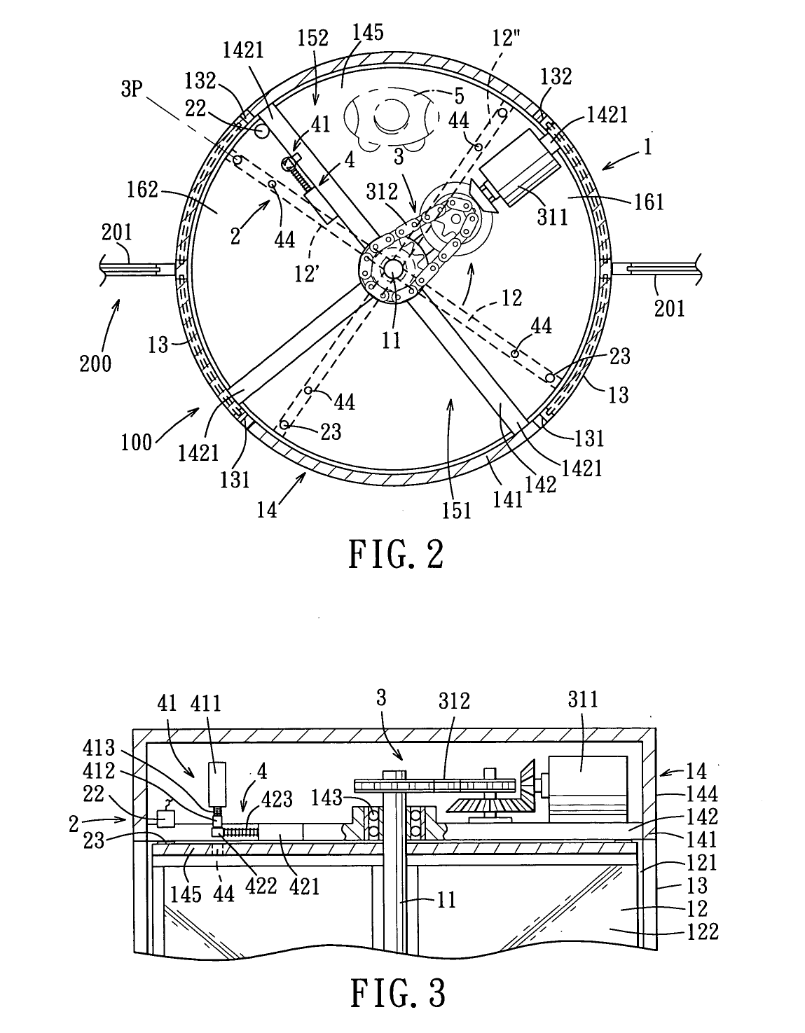

The lock mechanism 4 includes a first engaging portion 41 mounted on the stationary seat 14 at a location corresponding to the second position (2P), and a plurality of second engaging portions 44 disposed on the top plate 145 (see FIG. 2) and arranged respectively at locations corresponding to the positions of the door wings 12. The first engaging portion 41 is interlockable with one of the second engaging portions 44. The first engaging portion 41 includes a first electromagnetic device 411 fixed on the cross frame 142 and having a magnetically-operated first plunger 412 mounted movably and vertically, and a first spring member 413 sleeved on the first plunger 412 to urge the first plunger 412 to move downwardly.

A disengaging unit is provided to stop the first engaging portion 41 from engaging the corresponding second engaging portion 44, and includes a second electromagnetic device 421 fixed on the cross frame 142 adjacent to the first electromagnetic device 411 and having a magnetically-operated second plunger 422 mounted movably and horizontally, and a second spring member 423 sleeved on the second plunger 422 to urge the second plunger 422 toward the first plunger 412. In this embodiment, each of the first and second spring members 413, 423 is a compression spring. Each second engaging portion 44 is formed as a hole in a top surface of the top plate 145. In this embodiment, there are four second engaging portions or holes 44, each of which is aligned with a corresponding one of the door wings 12. The first plunger 412 is movable downwardly to engage one of the second engaging portions or holes 44 when the first and second door wings 12′, 12″ reach respectively the first and second positions (1P, 2P).

The drive unit 3 is coupled to the revolving door 1 and is further coupled to and controlled by the position detecting unit 2 to rotate the door wings 12 to a standby position (3P) (see FIG. 2) before the first signal is produced by the position detecting unit 2. The drive unit 3 includes a motor 311 fixed on the cross frame 142, and a transmission mechanism 312 interconnecting the shaft 11 and the motor 311. The transmission mechanism 312 includes a sprocket wheel and a chain. Alternatively, other types of transmission mechanisms 312 can be suitably used in the present invention. The position detecting unit 2 produces a second signal prior to the first signal to stop the drive unit 3 when the first door wing 12′ moves past the second position (2P).

In normal situations, the drive unit 3, the position detecting unit 2, and the lock mechanism 4 of the controlling unit are deactivated. As the first and second electromagnetic devices 411, 421 are not energized, the second spring member 423 urges the second plunger 422 toward the first plunger 412 so as to block a lower end of the first plunger 412, thereby preventing the first plunger 412 from moving downwardly, as best illustrated in FIG. 3. At this time, the lock mechanism 4 does not affect the rotation of the door wings 12.

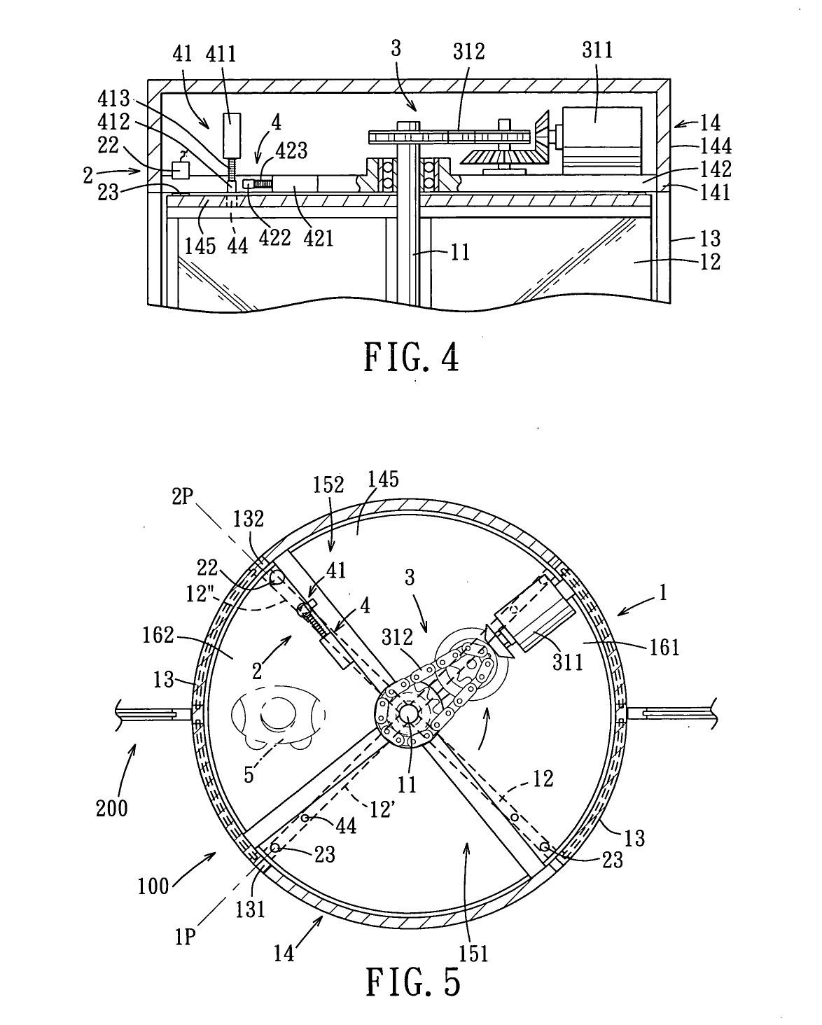

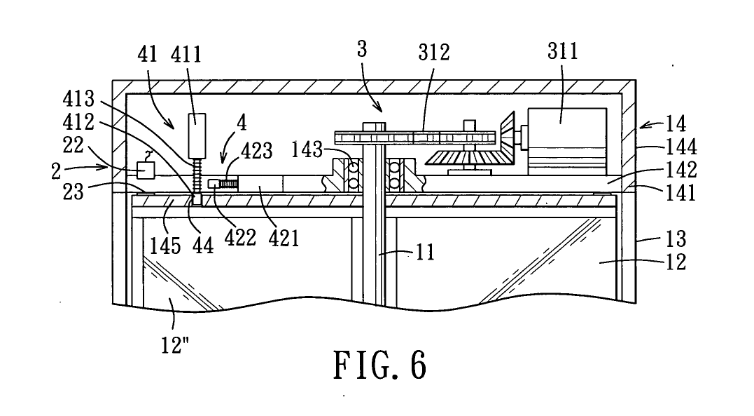

Referring back to FIG. 4, when the controlling unit is activated, the second electromagnetic device 421 is first energized so that the second plunger 422 is magnetically retracted and moves away from the first plunger 412. At this time, through gravity and through the urging of the first spring member 413, the first plunger 412 can move downwardly, and initially abuts against the top surface of the top plate 145. When the second door wing 12″ rotates to the second position (2P), the hole or the second engaging portion 44 corresponding to the second door wing 12″ and the first plunger 412 are aligned so that the first plunger 412 can advance downwardly to engage the hole 44 for retention therein, as best shown in FIG. 6. The door wings 12 stop rotation at this time, and a passerby 5, such as a robber, can be trapped within the trap space 162 (see FIG. 5).

When a robbery occurs, a controller, such as a bank employee (not shown), may activate the controlling unit. In this situation, the motor 311 of the drive unit 3 is actuated so as to rotate the door wings 12. As soon as the first door wing 12′ moves past the second position (2P), a second signal is generated by the light sensor 22 of the position detecting unit 2 prior to the generation of the first signal to stop rotation of the motor 311. Due to inertial force, the first door wing 12′ moves to the standby position (3P). At this moment, the light sensor 22 generates the first signal. In response to the first signal, the second electromagnetic device 421 is energized so that the second plunger 422 is magnetically retracted and moves away from the first plunger 412, thereby permitting the first plunger 412 to move downward. When the robber 5 reaches the door wings 12, he will push forward the first door wing 12′. As soon as the second door wing 12″ reaches the second position (2P), the first plunger 412 extends into the hole 44 immediately therebelow, thereby locking the second door wing 12″. At this time, the first door wing 12′ stops at the first position (1P), and the second door wing 12″ is positioned at the second position (2P).

All the door wings 12 are therefore prevented from rotation at this moment, and the robber 5 is trapped within the trap space 162. To arrest the robber 5, the controller may reactivate the controlling unit so that the first electromagnetic device 411 is energized to unlock the door wings 12. At this time, the first plunger 412 is removed from the corresponding hole 44, whereas the second electromagnetic device 421 is de-energized so that the second plunger 422 is urged by the second spring member 423 to move toward and block the first plunger 412. The first door wing 12′ can now be continuously rotated once again so as to permit removal of the robber 5 from the trap space 162.

From the aforementioned construction and operating method of the controlling unit, it is apparent that a specific passerby 5, such as the robber, can be trapped temporarily within the trap space 162, such that the robber is not only prevented from escaping, but is also isolated from the people inside and outside of the premise so that the people are protected from harm. Thus, the present invention obtains a dual purpose. Moreover, the controlling unit can ensure that the passerby 5 will enter the trap space 162 and be limited therein.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A security revolving door assembly comprising:
a revolving door having a rotary vertical shaft, a vertical lateral wall with an arc-shaped cross-section and extending circumferentially relative to said vertical shaft, and a plurality of door wings mounted on and extending radially from said shaft toward said lateral wall, said door wings having distal ends disposed away from said shaft and including a first door wing and a second door wing following said first door wing, said door wings being rotatable along with said shaft and defining with said lateral wall a trap space when said first and second door wings reach respectively first and second positions which are spaced apart angularly, said second position lagging said first position, said distal ends of said first and second door wings confronting said lateral wall when said first and second door wings reach respectively said first and second positions; and
a controlling unit coupled to said revolving door and operable so as to stop rotation of said door wings as soon as said door wings define said trap space.

2. The security revolving door assembly as claimed in claim 1, wherein said controlling unit includes a sensor for detecting when one of said first and second door wings reaches one of said first and second positions.

3. The security revolving door assembly as claimed in claim 1, further comprising a stationary seat adjacent to said revolving door, said controlling unit including a position detecting unit detecting whether or not said first door wing passes through said second position, and a lock mechanism which includes a first engaging portion mounted on said stationary seat, and a plurality of second engaging portions connected to said door wings and arranged respectively at locations corresponding to the positions of said door wings, said first engaging portion being interlockable with one of said second engaging portions.

4. The security revolving door assembly as claimed in claim 3, wherein said stationary seat is disposed above said door wings.

5. The security revolving door assembly as claimed in claim 3, wherein said controlling unit further includes a drive unit coupled to said revolving door and operable so as to rotate said door wings to a standby position, said drive unit being coupled to and controlled by said position detecting unit.

6. The security revolving door assembly as claimed in claim 4, further including a top plate disposed on top of said door wings and connected to said door wings for simultaneous rotation with said door wings, each of said second engaging portions having a hole formed in said top plate and aligned with a corresponding one of said door wings.

7. The security revolving door assembly as claimed in claim 6, wherein said first engaging portion includes a first electromagnetic device with a magnetically-operated first plunger, which is movable downwardly to engage said hole in the corresponding one of said door wings.

8. The security revolving door assembly as claimed in claim 7, wherein said first engaging portion further includes a first spring member sleeved on said first plunger to urge said first plunger to move downwardly.

9. The security revolving door assembly as claimed in claim 7, wherein said controlling unit further includes a second electromagnetic device with a magnetically-operated second plunger which is movable toward said first plunger to prevent said first plunger from moving downwardly.

10. The security revolving door assembly as claimed in claim 9, wherein said first engaging portion further includes a second spring member sleeved on said second plunger to urge said second plunger toward said first plunger.

11. The security revolving door assembly as claimed in claim 5, wherein said drive unit includes a motor, and a transmission mechanism interconnecting said shaft and said motor.

12. The security revolving door assembly as claimed in claim 3, wherein said position detecting unit includes a light sensor.

13. The security revolving door assembly as claimed in claim 12, wherein said light sensor is mounted on said stationary seat at a location corresponding to said second position, said position detecting unit further including a plurality of reflector plates respectively associated with said door wings and associated operably with said light sensor.
